(19) United States
(12) Patent Application Publication
(10) Pub. No.: US 2017/0291283 A1
(43) Pub. Date: Oct. 12, 2017

(54) WIRE PULLING GRIP

(71) Applicant: Klein Tools, Inc., Lincolnshire, IL (US)

(72) Inventors: John Kargenian, Prospect Heights, IL (US); Russell A. Goldmann, II, Highland Park, IL (US)

(73) Assignee: Klein Tools, Inc., Lincolnshire, IL (US)

(21) Appl. No.: 15/482,455

(22) Filed: Apr. 7, 2017

Related U.S. Application Data
(60) Provisional application No. 62/320,025, filed on Apr. 8, 2016.

(51) Int. Cl. B25B 9/00; H02G 1/08; B25B 25/00

(52) U.S. Cl. CPC B25B 9/00; B25B 25/00; H02G 1/085

(57) ABSTRACT

A wire pulling grip includes a main body, at least one cable-engaging jaw connected to the main body, and at least one cable-engaging surface included on the at least one cable-engaging jaw. A coating is disposed at least partially along the at least one cable-engaging surface, the coating including a plurality of surface protrusions arranged and configured to plastically deform an elastic cable jacket without slipping or tearing when a cable having the elastic cable jacket is engaged by the at least one cable-engaging jaw.

### CROSS-REFERENCE TO RELATED APPLICATIONS

The instant application claims the benefit of U.S. Provisional Patent Application Ser. No. 62/320,025, which was filed on Apr. 8, 2016, and which is incorporated herein in its entirety by this reference.

### FIELD OF THE DISCLOSURE

The present disclosure relates to hand tools and, more particularly, to jaw wire pulling grips.

### BACKGROUND

Jaw wire pulling grips are known for pulling wires. Parallel jaw clamps, for example, for tensioning electrical conductors have been known since the early days of electrical transmission. One example of a previously proposed set of jaw clamps can be found in U.S. Pat. No. 531,700 to Rowland. One main advantage of a parallel jaw grip is that the force used to tension the cable is translated and proportional to a holding force on the cable. The cable is engaged between the grip's jaws and, and the holding force results from a lever action of the grip. As a tension force on the cable is increased, the holding force applied on the cable between parallel jaw grips also increases. The proportionality or dependence between cable tension and cable holding force reliably discourages cable slippage from the grip. Other types of grips, for example, eccentric jaw grips, are also known.

Various designs for the surfaces of the jaw that engage the cable to be tensioned have been used in the past. The shape or design of the jaw is generally selected to accommodate different cable types and thicknesses. In certain applications, the jaws are designed for engaging copper or aluminum cables, and have smooth, rounded jaw surfaces that are intended to increase the contact area between the jaws and the cable that is engaged in the jaws. The rounded shape is also intended to preserve the shape and integrity of the cable. In other applications, for example, in grips designed for pulling steel cables, the jaws have a v-shaped cross section that is intended to increase the clamping force rather than the contact area. Certain other applications include knurling patterns formed in the engagement areas of the jaws, which “dig” into the outer cable surfaces to increase the pull-out force that is required to disengage the cable from the clamp during service.

One drawback of known parallel jaw grip designs is that they do not work particularly well with jacketed cables. Poly-vinyl-chloride (PVC) or high density polyethylene (HDPE) jacketed cables, for example, have a low friction coefficient and are generally “slippery” when subjected to a clamping force or pressure, and are thus known to compress and slip through a known cable grip design. In the past, cable grip jaw designs having teeth formed along the cable-engaging surfaces of the jaws have been proposed to avoid cable slippage relative to the grip, especially for cables having PVC or HDPE jackets. These previously proposed jaws operate to retain the cable in the grip as the teeth formed in the jaw surfaces partially penetrate the PVC or HDPE material of the cable jacket. Such penetration is intended to plastically deform the PVC or HDPE material layer of the jacket, which is expected to recover after the cable is removed from the clamp, but this is not always the case and cable damage can easily occur.

### BRIEF SUMMARY OF THE DISCLOSURE

In one aspect, the disclosure describes a wire pulling grip. The wire pulling grip includes a main body, at least one cable-engaging jaw connected to the main body, and at least one cable-engaging surface included on the at least one cable-engaging jaw. A coating is disposed at least partially along the at least one cable-engaging surface, the coating including a plurality of surface protrusions arranged and configured to plastically deform an elastic cable jacket without slipping or tearing when a cable having the elastic cable jacket is engaged by the at least one cable-engaging jaw.

In another aspect, the disclosure describes a method for gripping a cable having an elastic jacket. The method includes providing a main body onto which at least one cable-engaging jaw is pivotally connected, providing at least one cable-engaging surface on the at least one cable-engaging jaw, the at least one cable-engaging surface being shaped to conform to an outer surface shape of a cable jacket, and frictionally engaging the cable jacket with the at least one cable-engaging surface by providing a coating disposed at least partially along the at least one cable-engaging surface, the coating including a plurality of surface protrusions arranged and configured to plastically deform the cable.

### BRIEF DESCRIPTION OF THE SEVERAL VIEWS OF THE DRAWINGS

FIG. 1 is a top front perspective view of a grip in accordance with the disclosure.

FIG. 2 is a top front perspective view of one embodiment for a grip in accordance with the disclosure.

FIG. 3 is a bottom front perspective view of the grip shown in FIG. 2.

FIG. 4 is a cross section of the grip shown in FIG. 2 with an HDPE-jacketed cable in the jaws.

FIG. 5 is a top front perspective view of an alternative embodiment for a grip in accordance with the disclosure.

FIG. 6 is a cross section of the grip shown in FIG. 5 with an HDPE-jacketed cable in the jaws.

FIG. 7 is a cross section along a major dimension of an interchangeable jaw grip liner shown in FIG. 5.

FIG. 8 is a cross section along a minor dimension of the interchangeable jaw grip liner shown in FIG. 7.

### DETAILED DESCRIPTION

The exemplary embodiments described herein in accordance with the disclosure are applicable to jaws for wire grips that are suitable for use with jacketed cables in which the jacket material is made of a relatively soft and pliable material such as high density polyethylene (HDPE), poly-vinyl-chloride (PVC), and the like. The systems and methods in accordance with the disclosure are applicable to any type of wire grip including parallel jaw grips, as described in the exemplary embodiment presented herein, but also applies to eccentric-jaw grips and any other known type of wire grip. As it may be appreciated, commercially used HDPE formulations are not as elastic as PVC formulations, which in use relative to wire grips typically causes HDPE jacketed cable jackets to tear, crack, or rend. Smooth v-shaped jaw engagement surfaces are also unable to sufficiently engage the HDPE jackets of cables, especially in wet or cold conditions, in large part because HDPE has a low friction coefficient even under pressure. The present disclosure aims in rectifying these and other known issues with HDPE jacketed cable pretention in grips by introducing a new grip jaw cable engagement surface arrangement.

In the described embodiment, a parallel jaw wire pulling grip is disclosed having improved surface finish on the cable engaging portions of the jaws. The disclosed wire grip is exemplary and the disclosure herein is not limited to a parallel jaw grip. The disclosed wire grip has improved gripping and pulling properties for jacketed cables, particularly cables with a high density polyethylene (HDPE) jacket, or with a PVC jacket, with minimum trauma to the jacket of the cable. The parallel jaw wire pulling comprises a cable pulling grip with at least one jaw being surface treated with a hard, high friction material affixed to the grip's jaw surface.

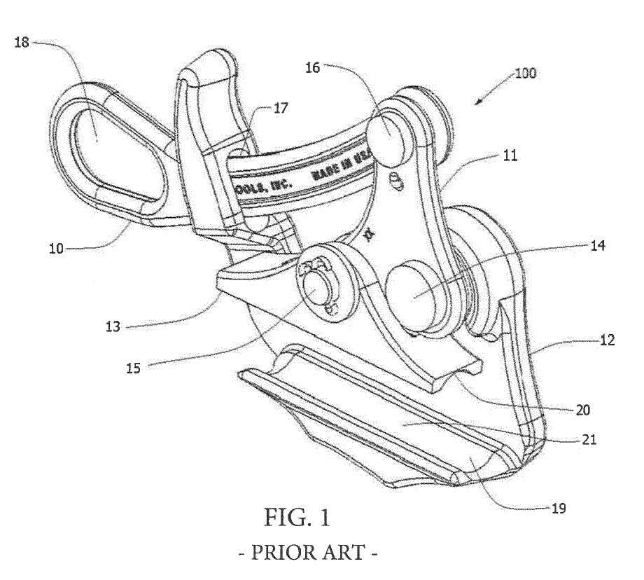

FIG. 1 depicts a wire pulling grip 100 having improved jaw cable engaging surfaces in accordance with the disclosure. The wire pulling grip 100 has an exemplary component arrangement that is typical for some wire grip types, but other configurations may be used. The wire pulling grip 100 includes a pulling arm 10, a lever arm 11, a main body 12, and an upper jaw 13. The pulling arm 10 is pivotally connected with the lever arm 11 via a lever rivet 16. Similarly, the lever arm 11 is pivotally connected with the main body 12 via a grip rivet 14, and the upper jaw 13 is pivotally connected with the lever arm 11 via a jaw rivet 15. The lever arm 11 is thus configured as a three-bar linkage to apply a lever advantage between the pulling arm 10 and the upper jaw 13. In other words, when the pulling arm 10 is pulled under cable tension, by means of an eye loop 18, away from the main body 12 of the wire pulling grip 100, the cable tension is applied to the lever arm 11 to create a mechanical advantage leverage across the lever rivet 16 which acts as a fulcrum and transfer the cable tension force into a clamping force applied to the upper jaw 13. The upper jaw 13 is placed in opposing relation to a lower jaw 19 such that the cable tension and, thus the clamping force direction, are applied to urge the upper jaw 13 towards the lower jaw 19, which is integrated with the main body 12, to create a clamp that will engage a wire (not shown) that will be pinched or otherwise clamped between the upper and lower jaws 13 and 19.

An upper jaw surface 20 that engages a wire disposed between the jaws, and also the lower jaw surface 21 that engages the wire of are machined with a concave, elongate cross section that follows and surrounds portions of the wire to maximize the contact surface area that contacts a cable or wire (not shown). This surface profile is selected to correspond to the particular wire shown and can be changed relative to what is shown in FIG. 1 to accommodate different wire diameters and different wire materials, as described above. For example, the cross section of the cable engaging surfaces of the jaws can be changed from the generally chordal cross section shown to have a V-shaped, polygonal, or non-elongate or non-uniform cross section profile. For example, in an alternative embodiment, one or both of the upper jaw surface 20 and the lower jaw surface 21 may be knurled or machined with transverse ridges or “teeth” to increase the aggressiveness of the wire pulling grip 100.

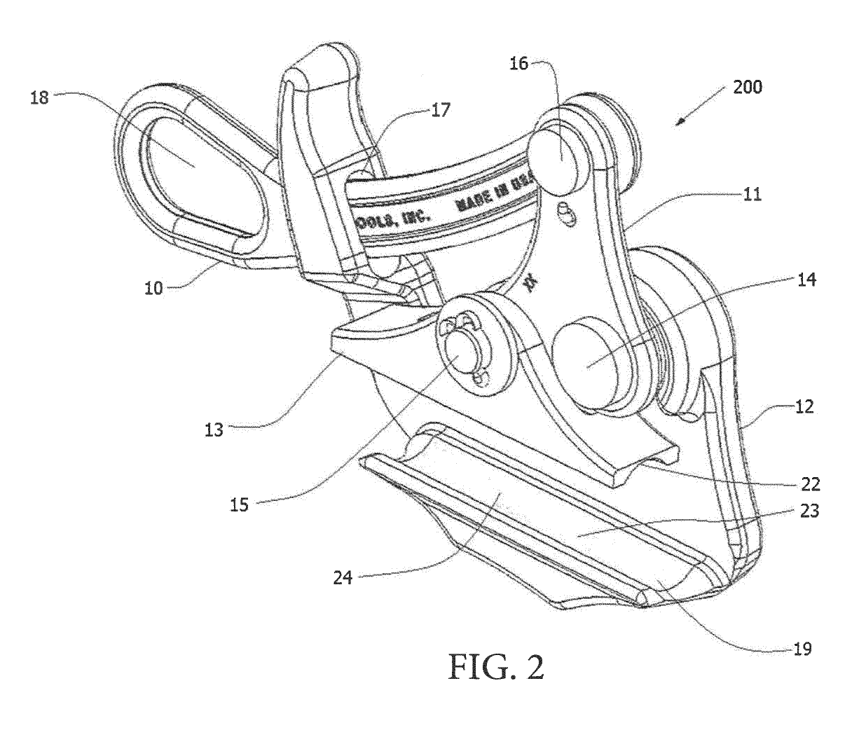

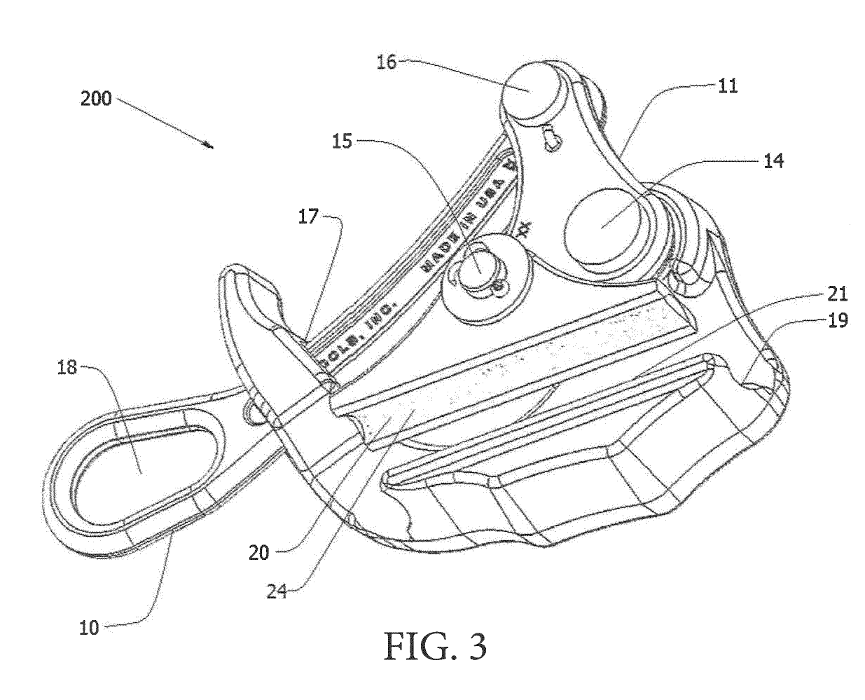

FIG. 2 and FIG. 3 depict an alternative embodiment for a wire pulling grip 200 in accordance with the disclosure. In this embodiment, the upper jaw surface 22 and lower jaw surface 23 of the wire pulling grip 200 are at least partially treated with compound having a high roughness and, optionally, is deposited such that it presents a high friction coefficient with materials it contacts. In the illustrated embodiment is a boron carbide material coating 24 that has been thermally sprayed and permanently bonded to each of the lower jaw surface 23 and the upper jaw surface 22. The boron carbide material coating 24 provides very high friction and penetrative ability to pierce and grab an HDPE cable jacket (not shown). In the embodiment shown, the coating applied to the jaw surfaces is selected based on the roughness and thickness of the coating of a cable that will be engaged with the jaws, and has been applied to produce a surface roughness on the jaws having an Ra of about 700μ-in (2.75 μm), but other surface roughness coatings or treatments may be used. In general, the surface roughness can be anywhere in the range of 250 to 1000μ-in (0.98 to 3.95 μm) for most typical cables available on the market today, but this range can be extended to cover special application cables and jacket thicknesses.

Because HDPE is not nearly as hard as a metallic cable, one typical drawback of the boron carbide material coating 24, its high brittleness, is not a factor in this application. It should be appreciated that, apart from a coating technique, and also apart from use of boron carbide as the grit material to be coated, other techniques and processes may also be used to create a desired surface roughness on the contact surfaces of the jaws. For example, mechanical abrasion to create roughness, electrical vapor deposition techniques, interchangeable inserts having rough faces that are attached to the jaws and have different roughness that is suitable for different cable types, and other techniques, can be used to construct a wire grip having at least one surface area of a jaw that is arranged to engage a cable can be used.

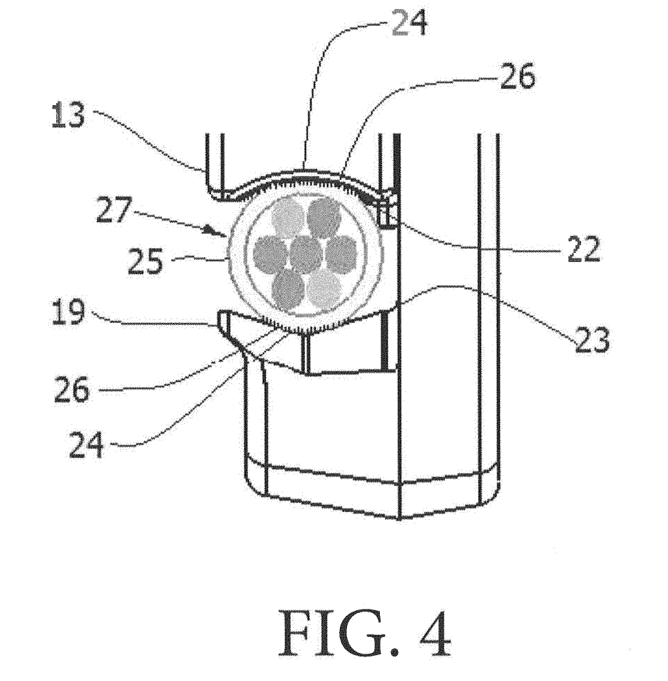

FIG. 4. is a cross section through the upper jaw 13 and the lower jaw 19. In this illustration, a section of a cable 25 is shown engaged between the upper and lower jaws 13 and 19. The cable 25 has an HDPE jacket 27 disposed around the cable's core strands. The boron carbide material coating 24 that is disposed onto the contact surfaces of the upper and lower jaws forms protrusions 26 that are plastically deforming the jacket locally to create elastic depressions in the HDPE jacket 27. The large number and small size of the protrusions 26 ensures a good grip on the HDPE-jacketed cable 25 with a minimum of damage to the HDPE jacket 27. Because of the very large number of protrusions 26 spread over the circumference of the HDPE-jacketed cable 25, no high stress point forms on the HDPE jacket 27 and thus no tears form in the HDPE jacket 27.

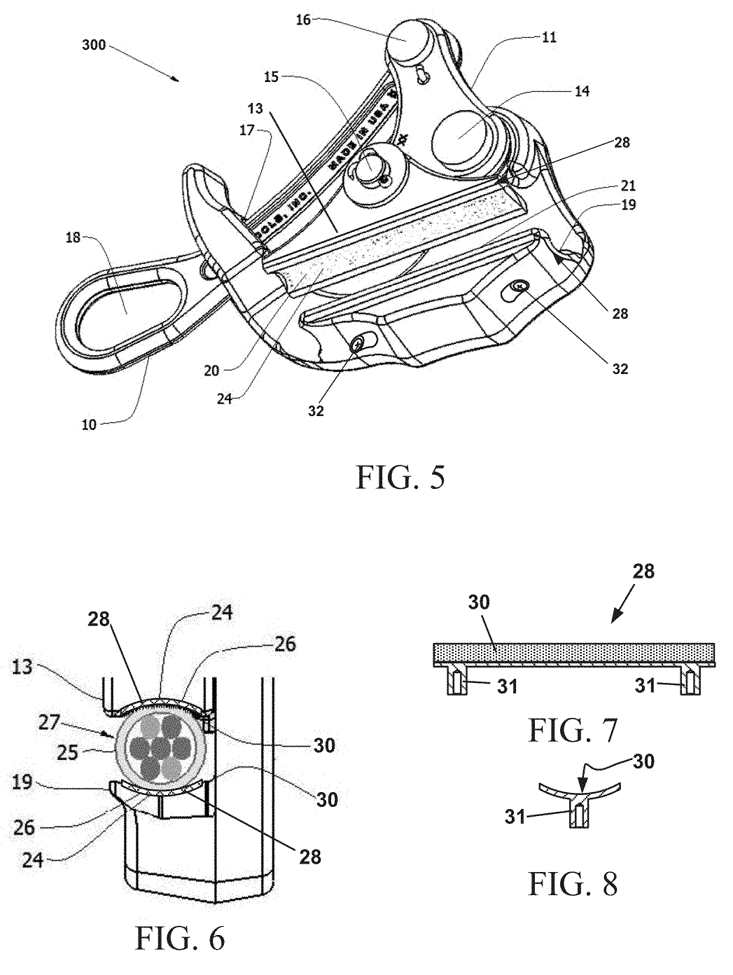

An alternative embodiment of a wire grip 300, which includes interchangeable jaw grip liners 28, is shown in FIG. 5, with a cross-section thereof shown in FIG. 6 and with detailed cross sections through the jaw grip liner 28 shown in FIGS. 7 and 8, As shown, each jaw grip liner 28 includes a generally cylindrical body 29 having an inward-facing surface 30 that contacts the cable 25, The coating 24 is deposited onto the inward-facing surfaces 30. Two liners 28 are used on the upper and lower jaws 13 and 19.

The liners 28 may be removably attached to the respective jaws by fasteners, which can include screws, magnets, a slot that cooperates with a bendable tooth, and the like, or may alternatively be attached by semi-permanent fasteners such as rivets, and adhesive and the like. In the illustrated embodiment, each liner 28 includes two threaded bosses 31, each of which passes through an opening in the corresponding jaw and is secured therein by a screw 32, as shown in FIG. 5. In this way, each jaw can be either added to retrofit an existing wire grip, or be replaced when worn without the need to replace the entire grip. The body of each liner 28 can be made from any suitable material including plastic, metal, ceramic and the like, and can be customized to suit a particular range of cable diameter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A wire pulling grip, comprising:
a main body;
at least one cable-engaging jaw connected to the main body; and
at least one cable-engaging surface included on the at least one cable-engaging jaw; and
a coating disposed at least partially along the at least one cable-engaging surface,
wherein the coating is made from a high surface roughness compound.

2. The wire pulling grip of claim 1, wherein the coating includes a plurality of surface protrusions arranged and configured to plastically deform a cable.

3. The wire pulling grip of claim 1, wherein the coating is deposited onto the at least one cable-engaging surface via a thermal spray operation such that the coating is permanently bonded with the at least one cable-engaging surface.

4. The wire pulling grip of claim 3, wherein the at least one cable-engaging surface is disposed on a jaw grip liner, the jaw grip liner being releasably connected to the at least one cable-engaging jaw via an adhesive.

5. The wire pulling grip of claim 3, where in the at least one cable-engaging surface is disposed on a jaw grip liner, the jaw grip liner being releasably connected to the at least one cable-engaging jaw via a fastener.

6. The wire pulling grip of claim 1, wherein the coating is made from a boron carbide material.

7. The wire pulling grip of claim 1, wherein the coating has a surface roughness Ra of about 700μ-in.

8. The wire pulling grip of claim 1, wherein the coating has a surface roughness Ra in the range from 250 to 1000μ-in.

9. The wire pulling grip of claim 1, wherein the at least one cable-engaging surface has an elongate shape that defines a concave surface configured to follow and surround a portion of the elastic cable jacket.

10. The wire pulling grip of claim 1, further comprising:
a lever arm pivotally connected to the main body via a grip rivet;
a pulling arm pivotally connected to the lever arm via a lever rivet; and
an upper jaw that forms the at least one cable-engaging jaw, the upper jaw being pivotally connected to the lever arm via a jaw rivet;
wherein the lever arm is configured as a three-bar linkage and configured to apply a lever advantage between the pulling arm and the upper jaw.

11. The wire pulling grip of claim 1, further comprising at least one additional cable-engaging jaw connected to the main body and having at least one additional cable-engaging surface disposed in opposing relation to the at least one cable-engaging surface to form a pair of cable-engaging surfaces, wherein the pair of cable-engaging surfaces are configured to compress a section of the cable therebetween in diametrically opposing relation.

12. The wire pulling grip of claim 10, wherein the coating is disposed at least partially along each of the pair of cable-engaging surfaces.

13. The wire pulling grip of claim 10, wherein the at least one additional cable-engaging jaw is a lower jaw that is formed integral with the main body.

14. A method for gripping a cable having an elastic jacket, comprising:
providing a main body onto which at least one cable-engaging jaw is pivotally connected;
providing at least one cable-engaging surface on the at least one cable-engaging jaw, the at least one cable-engaging surface being shaped to conform to an outer surface shape of a cable jacket; and
frictionally engaging the cable jacket with the at least one cable-engaging surface by providing a high surface roughness coating disposed at least partially along the at least one cable-engaging surface.

15. The method of claim 14, wherein the coating is deposited onto the at least one cable-engaging surface via a thermal spray operation such that the coating is permanently bonded with the at least one cable-engaging surface.

16. The method of claim 14, wherein the coating is made from a boron carbide material.

17. The method of claim 14, wherein the coating has a surface roughness Ra of about 700μ-in.

18. The method of claim 14, wherein the coating has a surface roughness Ra in the range from 250 to 1000μ-in.

19. The method of claim 14, wherein the at least one cable-engaging surface has an elongate shape that defines a concave surface configured to follow and surround a portion of the elastic cable jacket.

20. The method of claim 14, further comprising:
pivotally connecting a lever arm to the main body via a grip rivet;
pivotally connecting a pulling arm to the lever arm via a lever rivet; and
providing an upper jaw that forms the at least one cable-engaging jaw, and pivotally connecting the upper jaw to the lever arm via a jaw rivet;
wherein the lever arm is configured as a three-bar linkage and operates to apply a lever advantage between the pulling arm and the upper jaw.

21. The method of claim 14, further comprising providing at least one additional cable-engaging jaw connected to the main body and having at least one additional cable-engaging surface disposed in opposing relation to the at least one cable-engaging surface to form a pair of cable-engaging surfaces, wherein the pair of cable-engaging surfaces are operates to compress a section of the cable therebetween in diametrically opposing relation.

22. The method of claim 14, wherein the coating is disposed at least partially along each of the pair of cable-engaging surfaces.
